(19) United States
(12) Patent Application Publication
(10) Pub. No.: US 2007/0196644 A1
(43) Pub. Date: Aug. 23, 2007

(54) Polymer Films With Treated Fillers And Products And Methods Of Using Same

(76) Inventors: Wen Pao Wu, Pittsford, NY (US); David V. Dobreski, Canandaigua, NY (US)

Correspondence Address: BAKER BOTTS L.L.P., 30 ROCKEFELLER PLAZA, 44th Floor, NEW YORK, NY, 10112-4498, US

(21) Appl. No.: 11/687,463

(22) Filed: Mar. 16, 2007

Related U.S. Application Data
(63) Continuation of application No. PCT/US05/33004, filed on Sep. 16, 2005.
(60) Provisional application No. 60/611,264, filed on Sep. 17, 2004.

(51) Int. Cl. B32B 5/16

(52) U.S. Cl. 428/323

(57) ABSTRACT

The present invention provides for a polymer composite film with a treated filler and methods for making the same. The polymer composite film includes a polymer capable of being formed into a polymeric film and a treated filler which is dispersed throughout the polymer forming the composite film. The filler is treated by techniques which exfoliate, delaminate or intercalate the filler particles into individual micro and/or nano size particulates and platelets. Ideally, the treated filler has a medium particle size ranging from about 0.1 nm-10 mm. The treated filler enhances the rigidity, barrier properties, heat deflection temperature, clarity, nucleation characteristics and fire retardant characteristics of the film. The products fabricated from the polymer composite film include sleeves, protective packaging, films, bags, liners, house-wraps, overwrap films, bubble cushion, packaging for food products, boil-in bags, heat shrinkable films, heat shrinkable bags, pouches, and thermoformed packages. The present invention also provides for methods of fabricating the polymer composite film.

### BACKGROUND OF THE INVENTION

1. Field of the Invention

The present invention relates to a polymer material with treated fillers and articles and methods of using same. Particularly, the present invention is directed to the use of treated filler materials in the manufacture of polymer composite films, to be formed or molded into packaging or consumer products having enhanced properties.

2. Description of Related Art

Packaging and protective structures such as boxes, containers, trays, cups, dinnerware, films, bags, wraps and the like, are formed from a variety of thermoplastic and thermosetting polymers. Mineral fillers are used extensively to enhance the performance of a wide range of such polymers. It is well known that the improvement in the properties of polymers can occur with the proper use of well-dispersed fillers possessing high aspect ratios and small particle sizes. Physical properties of the polymer that can be improved by the use of such fillers include stiffness, strength, temperature resistance, dimensional stability, surface hardness and scratch resistance. Other properties that can be improved with the use of well-dispersed fillers possessing high aspect ratios and small particle sizes include clarity, chemical resistance, flame retardancy, rheological properties, and crystallinity. Such fillers can also be used to reduce permeability to gases and liquids, thereby improving the barrier property of the polymer.

The most commonly used fillers in plastics are calcium carbonate, wollastonite, silica and the phyllosilicates such as kaolin, talc and mica. Many fillers, such as calcium carbonate, silica and phyllosilicates, however, are hydrophilic and therefore must be surface treated in order to improve their dispersion and interaction with the polymer matrix. Conventional surface treatment of fillers includes reacting the filler surfaces with organosilanes, modified oligomers and polymers containing anhydride functional groups and a wide variety of surfactants. More recently, it has been determined that the exfoliation and nanoscale dispersion of small amounts of treated fillers into polymers results in composite materials with enhanced physical features and significant reductions in weight as compared to polymers with conventional or non-treated fillers. Nanocomposites are a new class of composites that are particle-filled polymers for which at least one dimension of the dispersed filler is in the nanometer range (10⁻⁹ meter).

Various methods are known in the art for creating composites with modified fillers which are exfoliated and dispersed in a polymer matrix. Under current methods known in the art, large quantities of volatile polar surfactants are required to ensure complete exfoliation, intercalation or delamination of fillers. There thus remains a need for enhancing the properties of polymer composite films through the use of treated fillers, particularly, fillers that do not require large quantities of surfactants.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof.

To achieve these and other advantages and in accordance with the purpose of the invention, as embodied and broadly described, the invention is directed to the use of treated fillers in the manufacture of a polymer composite film through conventional processing techniques. Such techniques include, but are not limited to co-extrusion, extrusion, extrusion coating, extrusion lamination, adhesive lamination and the like, and any combination thereof. The composite film is formed or molded into packaging or consumer products having enhanced physical properties. The products include, but are not limited to, sleeves, protective packaging, films, bags, liners, house-wraps, overwrap films, bubble cushion, void fillers, packaging for food products, boil-in bags, heat shrinkable films, heat shrinkable bags, pouches, and thermoformed packages.

In accordance with the invention, the polymer composite film includes a polymer capable of being formed into a polymer film and a treated filler having a median particle size of about 0.1 nm-10 μm, wherein the treated filler is dispersed throughout the polymer.

In further accordance with the invention, the filler is treated by a process which delaminates, intercalates or exfoliates the filler. In accordance with a preferred embodiment of the invention, the filler is treated by an edge-modifying process, which preferably includes a surfactant absorbed along the edges of the filler. Generally the fillers include, but are not limited to, calcium carbonate, wollastonite, silica and phyllosilicates.

In accordance with the invention, the treated filler enhances at least one physical property of the polymer film including, rigidity, stiffness, barrier property, heat deflection temperature, clarity, nucleation, and fire retardancy of the film.

In a further embodiment, the invention is directed to a multi-layer polymer composite film. Preferably, the multi-layered composite film has at least one layer including a polymer and a treated filler.

In yet a further embodiment, the invention includes a polymer composite film including a polymer capable of being formed into a polymeric film, a treated filler having a median particle size of about 0.1 nm-10 μm, and a non-treated filler, wherein both the treated and non-treated fillers are dispersed throughout the polymer matrix.

In yet a further embodiment, the invention includes a method for fabricating a polymer composite film by treating a filler by a process which delaminates, exfoliates or intercalates the filler, dispersing the treated filler to a polymer matrix and forming the polymer matrix into a polymer composite film.

It is to be understood that both the foregoing general description and the following detailed description are exemplary and are intended to provide further explanation of the invention claimed.

### DETAILED DESCRIPTION OF THE PREFERRED EMBODIMENT

The present invention provides for a polymer composite film with a treated filler for forming packaging and/or consumer products, and methods for making the same. The polymer composite film is manufactured using conventional processing techniques such as, for example, extrusion, extrusion coating, extrusion lamination, adhesive lamination, blown film, cast film, solution or solvent coating processes, molding techniques and the like, and any combination thereof.

As embodied herein, and in accordance with one aspect of the invention, the invention provides for a polymer composite film including a treated filler and polymer, wherein the treated filler is dispersed throughout the polymer. Improvement in the properties of polymers is facilitated by the use of well-dispersed fillers possessing high aspect ratios and small particle sizes. The aspect ration is defined as the ratio of a particle's major axis (e.g., length) to a minor axis (e.g., thickness), or alternatively, a particle's length to its diameter. In accordance with a preferred embodiment of the invention the aspect ratios of the fillers range from 5 to 500 and more preferably between 5 and 100.

Without being bound by a particular theory, it is desirable to enhance the delamination, intercalation or exfoliation of the filler particles into individual platelets or smaller particulates in order to maximize the properties of the resultant polymer composite film and ultimately the products manufactured therefrom. In accordance with a preferred embodiment of the invention, the fillers are delaminated such that the average platelet or median particle size ranges from about 0.1 nm to 10 μm.

There are many methods to produce treated fillers of nano and micro size particles for use in specific polymeric films. Generally, the methods can be grouped into three generic categories: (1) in situ polymerization; (2) solution intercalation; and (3) melt exfoliation. Such techniques are disclosed in U.S. Pat. No. 5,876,812, which is incorporated in its entirety by reference herein. Depending on the type of filler used, once treated, the fillers are segregated or separated into platelets or particulates. Any suitable process or technique which successfully reduces the particles of a filler into individual micro and/or nano size platelets or particulates may be used in the present invention. In accordance with a preferred embodiment of the invention, the fillers are treated by techniques which exfoliate, delaminate or intercalate the fillers as described further below. However, it shall be understood that any technique, conventional or non-conventional, which can reduce the particles of a filler into micro and/or nano size particulates or platelets may be used without departing from the spirit or scope of the invention.

Generally, it is desirable to treat the fillers, e.g. the clays or talcs; to facilitate separation of the agglomerates of platelet particles to individual particles and small tactoids. Typically, the fillers are treated by surfactants or swelling agents to modify the surface of the fillers and allow exfoliation, delamination and intercalation of the fillers into the polymer matrix. The polymer chains thus can be intercalated between the layers of the filler or the filler layers may be delaminated and dispersed in a continuous polymer matrix.

Intercalation generally is defined as the insertion of mobile guest species (atoms, molecules, ions) into a crystalline host lattice that contains an interconnected system of empty lattice sites of appropriate size. The intercalation process results in the development of intercalates which are more organophilic and which can be more readily exfoliated (dispersed) when mixed with a polymer to form an ionomeric nanocomposite. These intercalates are typically on the order of 1 nanometer thick, but about 100 to 1,000 nanometers across. The high aspect ratio, and the resulting high surface area, provides high reinforcement efficiency at low loading levels. Intercalation also can be accomplished by dispersing the nanostructured materials in a solution containing an oxidizing agent, e.g., a mixture of nitric acid and sulfuric acid.

In accordance with one embodiment of the invention, the treated filler is integrated into the polymer material matrix by intercalating the surfactant-mineral filler complex with the polymer material matrix to form an intercalated polymer materials. In this specific example, the intercalated polymer material has defined x-ray diffraction profile for an interlayer or gallery spacing. In an alternative embodiment, the integration of the treated filler into the polymer material matrix is accomplished by exfoliating the filler mineral into the polymer material matrix to form a polymer exfoliated filler material.

Several techniques are disclosed for the exfoliation, intercalation or delamination of filler particles. For example, U.S. Pat. No. 6,057,035, which is incorporated in its entirety by reference herein, discloses nanocomposites systems that are exfoliated with tetraphenyl phosphonium to achieve greater temperature stability.

U.S. Pat. No. 5,910,523, which is incorporated in its entirety by reference herein, discloses a composition including a semi-crystalline polyolefin, a clay filler having dispersible platelets in stacks, an amino-functional silane reacted with the filler, and a carboxylated or maleated semi-crystalline polyolefin that has been reacted with the amino-functional silane after the silane was reacted with the filler.

U.S. Pat. No. 6,222,903, which is incorporated in its entirety by reference herein, discloses a composition made by contacting a phyllosilicate material that is exfoliated in an organic solvent with a polymer/carrier composition that includes a water-insoluble polymer and a solvent, whereupon the adherent solvent is driven off.

U.S. Pat. No. 6,451,897, which is incorporated in its entirety by reference herein, discloses a composite material made in a substantially non-oxidizing environment by graft polymerizing a liquid monomer onto a propylene resin in the presence of smectite clay and a free radical initiator. The propylene resin is a porous material, wherein more than 40% of the pores have a diameter greater than 1 micron. The liquid monomer may be a vinyl-substituted aromatic, a vinyl ester, or an unsaturated aliphatic nitrite or carboxylic acid.

U.S. Pat. No. 6,462,122, which is incorporated in its entirety by reference herein, discloses a nanocomposite blend containing a layered silicate material, a matrix polyolefin, and a functionalized polyolefin (e.g., maleic-anhydride-modified polypropylene) that may be blended together in, for example, a twin-screw extruder.

U.S. Pat. No. 4,810,734, which is incorporated in its entirety by reference herein, discloses a process for producing a composite material by contacting a layered clay mineral with a swelling agent in the presence of a dispersion medium such as water, an alkanol, or dimethyl sulfoxide, mixing with a polymerizable monomer or a mixture of monomer and dispersion medium, and polymerizing the monomer in the mixture. Catalysts and accelerators for polymerization can also be present. The polymer that is formed can be, for example, a polyamide, a vinyl polymer, or a thermoset resin.

U.S. Pat. No. 5,514,734, which is incorporated in its entirety by reference herein, discloses a composite material including a polymer matrix having layered or fibrillar particles, e.g., phyllosilicates, uniformly dispersed therein, the particles being bonded to organosilanes, organo titanates, or organo zirconates and having one or more moieties bonded to at least one polymer in the polymer matrix.

U.S. Pat. No. 5,760,121, which is incorporated in its entirety by reference herein, discloses a composite material including a host material such as a polyamide, polyvinylamine, polyethylene terephthalate, polyolefin, or polyacrylate, and exfoliated platelets of a phyllosilicate material. The platelets are derived from an intercalate formed without an onium ion or silane coupling agent by contacting with an intercalant polymer-containing composition containing water and/or an organic solvent.

U.S. Pat. No. 5,9210,523, which is incorporated in its entirety by reference herein, discloses a composition including (a) a semi-crystalline polyolefin, (b) a clay filler having dispersible platelets in stacks, (c) an amino-functional silane reacted with the filler, and (d) a carboxylated or maleated semi-crystalline polyolefin that has been reacted with the aminofunctional silane after the silane was reacted with the filler.

In accordance with another aspect of the invention, surface treatment of the fillers, in particular those which are hydrophilic, includes reaction of the filler surface with organosilanes, modified oligomers and a wide variety of surfactants. The hydrophilic fillers generally must be surface treated to render them compatible with plasticizing polymers. The surfactant is a swelling agent which assists in the integration of the filler with the polymer material. Typically, the entire surface of the filler is treated with surfactant. However, in a preferred embodiment of the invention, the edges of the fillers are modified using various surfactants, such as, for example organophosphorus and organosulfur compounds. The fillers, such as phyllosilicates, are edge modified with various organic surfactants that preferentially are absorbed along the edges of the fillers. In particular, the edge-treatment improves the properties of the resulting polymer composite film because less surfactant can be used in the process. U.S. Patent Application 2003/0176537 (now issued as U.S. Pat. No. 6,790,896), which is incorporated in its entirety by reference herein, discloses an edge-treatment of phyllosilicates that uses a fraction of the amount of surfactant used by conventional exfoliation processes. The process can be applied to either an ion exchangeable phyllosilicate, such as a smectite clay or mica, or a non-ion exchangeable phyllosilicate.

Organic molecules suitable as surfactants or swelling agents include cationic surfactants such as ammonium, phosphonium or sulfonium salts; amphoteric surface active agents; derivatives of aliphatic, aromatic or arylaliphatic amines, phosphines and sulfides; and organosilane compounds. Other suitable swelling agents include protonated amino acids and salts thereof containing 2-30 carbon atoms such as 12-aminododecanoic acid, epsilon-caprolactam and like materials. A preferred swelling agent includes ammonium to effect partial or complete cation exchange.

The fillers used in the present invention include, but are not limited to, calcium carbonate, wollastonite, silica and the phyllosilicates such as kaolin, talc and mica. Suitable phyllosilicates for use in the invention are clays, including mica, kaolinite, and smectite, vermiculite, and halloysite clays, and naturally occurring hydrophobic minerals, such as talc. Natural or synthetic phyllosilicates, for example, are sheet structures basically composed of silica tetrahedral layers and alumina octahedral layers. Suitable smectite clays include montmorillonite, hectorite, saponite, sauconite, beidellite, nontronite and synthetic smectites such as Laponite™. Suitable phyllosilicates are available from various companies including Nanocor, Inc., Southern Clay Products, Kunimine Industries, Ltd., Rheox and Argonne National Labs. The phyllosilicates discussed herein have basal surfaces and are arranged in layers of particles stacked on top of one another. The stacking of the clay particles provides interlayers, or galleries, between the phyllosilicate layers. These galleries are normally occupied by cations, typically including sodium, potassium, calcium, magnesium ions and combinations thereof, that balance the charge deficiency generated by the isomorphous substitution within the clay layers. Typically, water is also present in the galleries and tends to associate with the cations.

The most preferred fillers in the polymer composite film of the present invention are those based on clays and talc. It is known that these layered phyllosilicates can be treated with organic molecules such as, e.g., organic ammonium ions to insert the organic molecules between adjacent planar silicate layers thereby increasing the interlayer spacing between the adjacent silicate layers. This process is known as intercalation and the resulting treated filler is generally referred to as a treated phyllosilicate. The thus-treated intercalated phyllosilicates have interlayer spacing of at least about 10- 20 Angstroms and up to about 100 Angstroms. In order to achieve good intercalation, exfoliation and dispersion of the clay minerals, processing conditions should be such that both shear rate and residence time are optimized. Generally, the layered clay material useful in this invention are an agglomeration of individual platelet particles that are closely stacked together like cards, in domains called tactoids. The individual platelet particles of the clays preferably have thickness of about 10 to about 3000 nm. The composites are typically obtained by the intercalation or penetration of the polymer (or a monomer subsequently polymerized) inside galleries of layered phyllosilicates and the subsequent exfoliation, or dispersion, of the intercalate throughout the polymer matrix.

Depending on the type of filler used and the degree of intercalation, exfoliation or delamination obtained, and the particle sizes, the treated filler can be present in any amount suitable to impart enhanced properties to the polymer composite film and products manufactured therefrom. In a preferred embodiment of the invention, the treated filler is present from about 0.1 to 30 weight percent in the polymer product, more preferably from about 3 to 20 weight percent. However, in accordance with yet another embodiment, the treated filler is present in very small amounts, such as, for example from about 300-1000 parts per million. It shall be understood that any suitable amount of treated filler capable of accomplishing a desired result may be used without departing from the spirit or scope of the invention.

In accordance with an exemplary embodiment of the invention, the preferred fillers are phyllosilicates such as talcs or clays which have been treated via edge-modifying techniques. In a preferred embodiment, the phyllosilicates are edge-modified using various organophosphorous and/or organosulfur compounds.

In accordance with a preferred embodiment of the invention, in order to obtain a polymer composite film with enhanced properties, the treated fillers should be exfoliated, intercalated or delaminated so as to be dispersed in the form of individual platelets or aggregates having sizes of about 0.1 nm-10 μm.

The polymeric component of the composite includes, but is not limited to, functionalized or non-functionalized propylene polymers, functionalized or non-functionalized ethylene polymers, functionalized or non-functionalized styrenic block copolymers, styrene butadiene copolymers, ethylene ionomers, styrenic block ionomers, polyurethanes, polyesters, polycarbonate, polystyrene, and mixtures or copolymers thereof.

Additional polymers suitable for use in the composite films of the present invention are exemplified, but not limited to, polyolefins such as low density polyethylene (LDPE), linear low density polyethylene (LLDPE), medium density polyethylene (MDPE), high density polyethylene (HDPE), and polypropylene (PP), polyamides such as poly(m-xyleneadipamide) (MXD6), poly(hexamethylenesebacamide), poly(hexamethyleneadipamide) and poly(epsilon-caprolactam), polyacrylonitriles, polyesters such as poly(ethylene terephthalate), polyactic acid (PLA), polycaprolactone (PCL) and other aliphatic or aromatic compostable or degradable polyesters, alkenyl aromatic polymers such as polystyrene, and mixtures or copolymers thereof. Other polymers suitable for use in the composites of the invention include ethylene vinyl alcohol copolymers, ethylene vinyl acetate copolymers, polyesters grafted with maleic anhydride, polyvinylidene chloride (PVdC), aliphatic polyketone, LCP (liquid crystalline polymers), ethylene methyl acrylate copolymer, ethylene-norbornene copolymers, polymethylpentene, ethylene acyrilic acid copolymer, and mixtures or copolymers thereof. Further polymers that may be used include epoxy and polyurethane adhesives.

Although not required, the oligomers and/or polymers of the present invention may also include suitable additives normally used in polymers. Such additives may be employed in conventional amounts and may be added directly to the reaction forming the functionalized polymer or oligomer or to the matrix polymer. Illustrative of such additives known in the art include, but are not limited to, colorants, pigments, carbon black, glass fibers, fillers, impact modifiers, antioxidants, stabilizers, flame retardants, reheat aids, crystallization aids, acetaldehyde reducing compounds, recycling release aids, oxygen scavengers, plasticizers, nucleators, mold release agents, compatibilizers, and the like, or their combinations.

In accordance with one aspect of the invention, the polymer film preferably has at least one layer including a polymer and a treated filler dispersed throughout the at least one layer to define the polymer film. In a further embodiment, the at least one layer further includes a non-treated filler dispersed throughout the at least one layer. In further accordance with the invention, the polymer composite film can have a multi-layered construction. The multi-layered polymer composite film can include at least one additional layer of polymer material, wherein the at least one additional layer includes a treated filler. In accordance with yet another aspect of the invention, the at least one additional layer includes a non-treated filler. Further in accordance with the invention, the multi-layered polymer composite film includes at least one layer including a polymer an a treated filler and at least one layer including a polymer and a non-treated filler. For purposes of illustration and not limitation, the polymer film can include a treated filler disposed adjacent to a second layer of the same or different properties or in a preferred embodiment disposed intermediate to two or more layers. Thus, the multi-layer polymer film may also contain one or more layers of the treated filler composite of this invention and one or more layers of a structural polymer. A wide variety of structural polymers may be used. Illustrative of structural polymers and polyesters, polyetheresters, polyamides, polyesteramides, polyurethanes, polyimides, polyehterimides, polyureas, polyamideimides, polyphenyleneoxides, phenoxy resins, epoxy resins, polyolefins, polyacrylates, polystyrene, polyethylene-co-vinyl alcohols (EVOH), and the like or their combinations and blends. In one embodiment, the preferred structural polymers are polyolefins such as polypropylenes and polyethylenes. In another embodiment, the preferred structural polymers are polyesters, such as poly(ethylene terephthalate) and its copolymers.

In yet another embodiment, the preferred structural polymers are alkenyl aromatic polymers, such as polystyrene and high impact polystyrene.

The multi-layer polymer composite film can be formed by a variety of processing techniques including, but not limited to, lamination, solvent or solution multi-layer coatings, co-extrusion, such as, for example, blown film co-extrusion or cast film co-extrusion. The multi-layer composite film can be composed entirely of a film material or multiple structural materials including, but not limited to, sheets, films, foams, paper and the like. In accordance with a preferred embodiment of the invention, the multi-layer polymer composite film is formed into products as described herein. Numerous advantages are provided in a multi-layer structure. For example, a multi-layer structure with outer(skin) layers having higher rigidity than that of the core layer material can impart an I-beam effect to the entire composite structure, resulting in a higher effective rigidity. A multi-layer structure also allows one to put the lower cost or performance material in the core layer to reduce cost.

In accordance with yet another aspect of the invention, the polymer composite film includes a blend of treated fillers, which have been exfoliated, intercalated or delaminated, and non-treated fillers. For example, and not limitation, the polymer composite film may include 0.03-15 weight percent of treated fillers and 5-60 weight percent of non-treated fillers. However, it shall be understood that any suitable ratio of treated filler to non-treated filler capable of accomplishing a desired result can be used without departing from the spirit or scope of the invention. In accordance with a preferred embodiment of the invention, the polymer composite film blend is formed into products as described herein.

In accordance with yet another aspect of the invention, the invention is directed to a polymer composite film including a blend of at least two polymers wherein at least one polymer contains a treated filler. The treated filler is typically dispersed throughout the polymer and enhances the properties of the entire polymer film blend. Typically, the polymers are compatible, however, the blend may also include incompatible polymers. Incompatible polymers typically include combinations of polymers that are relatively immiscible, that is, form a cloudy solution and/or cloudy dry film or complete phase separation when mixed. Incompatible polymers also include those that have partial compatibility with each other. However, the addition of a polymeric dispersant can act to aid in the compatibility of the mixture, providing a stable polymer blend. Typically, in a stable incompatible polymer blend, one of the incompatible polymers is dispersed as fibers throughout the mixture. This fiber-reinforced-polymer blend is a result of preparing the incompatible polymer blend using techniques as described in U.S. Pat. Nos. 4,716,201; 4,814,385 and 5,290,866, which are incorporated in their entirety by reference herein. To further enhance the property of the fiber-reinforced polymer film blend, the treated filler can be added to one of the incompatible polymers prior to creating the stable incompatible polymer blend and the properties of the incompatible blend, such as stiffness and strength can be enhanced.

Further in accordance with the invention, a method is provided for fabricating a polymer film, the method including the steps of treating a filler through processes which exfoliate, delaminate or intercalate the filler, dispersing the treated filler into a polymer matrix and forming the polymer matrix into a polymer composite film. In accordance with a preferred embodiment of the invention, the filler is treated by an edge-treatment process.

The composite film of the present invention may be produced by methods which are known in the art. These methods can be exemplified, but not limited to extrusion, co-extrusion, extrusion coating, extrusion lamination, adhesive lamination and the like, and any combination thereof. The composite film can also be produced via extrusion coating and lamination techniques. The composite of the present invention may also be oriented and/or cross-linked. The orientation of the film may be accomplished at any state of the process (i.e., the total film structure may be oriented or an individual layer or layers may be oriented prior to their inclusion in the total film product).

The treated-fillers can be incorporated into a polymer to form a filled polymer composite film through a number of processing methods, as discussed herein. In one embodiment, the polymer is melt-processed in a compounding extruder, preferably a twin screw extruder, before the treated-fillers are fed into the extruder through a side feeder. The melt-processing can be conducted with or without ultrasound assistance. The mixture of polymer and treated fillers is then melt-homogenized in the extruder, extruded through a strand-die into strands and cut into pellets. The pellets are then melt-processed in another extruder equipped with an annular or cast die to form films of desirable thickness. In another embodiment, the polymer and the treated fillers are melt-processed with a compounding extruder equipped with a film die, therefore, bypassing the pelletization step and extruding the composite directly into a film of desirable thickness.

Alternatively, the treated fillers can be added during the polymerization process instead of being added during the melt-processing method as described above. Preferably, the treated fillers are added to the reactor.

Alternatively, the treated filler can be dispersed in a solution or a solvent blending process. The polymer is dissolved in a solvent to form a solution, and the treated filler is added and mixed, so as to disperse the filler in the polymer matrix.

Further in accordance with the invention, the polymer composite film is formed into products by conventional plastic processing techniques. For example, and not limitation, the polymer film products can be fabricated by thermoforming extrusion, lamination or compression techniques, bag making, sealing or folding techniques, and other web converting techniques. The polymer composite film, which can be a single-layer or multi-layer construction, is formed into packaging and consumer products including but not limited to sleeves, protective packaging, films, bags, liners, house-wraps, overwrap films, bubble cushion, void fillers, packaging for food products, boil-in bags, heat shrinkable films, heat shrinkable bags, pouches, and thermoformed packages.

In accordance with one aspect of the invention, the polymer composite film is formed into several products as disclosed, for purpose of illustration and not limitation, in U.S. Pat. Nos. 5,709,641; 5,716,138; 5,752,362; 5,851,070; 5,967,663; 5,976,682; 5,989,725; 6,013,378; 6,059,458; 6,059,707; 6,089,753; 6,361,209; and 6,402,377, the disclosures of which are incorporated in their entirety by reference herein. In accordance with the invention, the physical properties of the products are enhanced through the use of treated fillers. It shall be understood that any product formed by a mineral filled polymer or a polymer alone can be formed with the use of a polymer composite material having treated fillers dispersed throughout the polymer.

Superior properties are accomplished at relatively lower filler loadings when compared to the loadings required for non-treated fillers due to the dispersion of the platelets and particulates in the polymer, and the creation of favorable interactions at the filler-polymer interface. The superior properties of new composite films are obtained at low inorganic loadings. The use of less filler content leads to significant advantages. Not only are the polymer properties such as stiffness, strength and barrier properties enhanced, however, considerable weight and cost savings are also achieved. As such, selected properties of a film formed of such treated filler polymers which are enhanced include rigidity, stiffness, barrier properties, clarity, heat resistance, thermal stability, dimensional stability, nucleation characteristics and flame retardancy characteristics.

The use of treated fillers such as, for example, edge-treated talc, imparts considerable enhancements to products formed from the composite film. For example, overwrap films, bags and liners fabricated from treated-filler polymer film are more rigid, stiffer and of a lower weight then comparable overwrap films, bags and liners made of non-treated fillers. The composite films having treated fillers are stiffer with enhanced ductility properties. For example, the use of polymer composites with treated fillers in low density polyethylene, soft cast or water quenched film applications allow for films that exhibit enhanced stiffness and ductility. Moreover, adding treated fillers to a fiber-reinforced-film further enhances the films stiffness and resiliency. The fiber-reinforced-films are described in details in U.S. patent application Ser. No. 10/775,601 filed Feb. 10, 2004, the disclosure of which is incorporated by reference herein.

The improved barrier properties imparted to the polymer film allow for its use in film products which are used in extended-shelf-life applications, such as, for example perishable goods and meats. Additionally, the improved barrier property reduced the need for multi-layer and laminate structures. For example, the conventional multi-layer film used to fabricate a bubble cushion product can be replaced with a monolayer treated-filler polyethylene film. Conventional films which typically do not possess any barrier properties can now exhibit such barrier properties. The improved barrier properties of the composite film having treated fillers are demonstrated through measurements of relative permeability of liquids and gases through the polymer composite film that is formed.

Dramatic reductions in permeability are obtained at low treated filler concentrations compared to conventionally-filled polymers with much higher filler concentration. Without being bound by theory, the lower permeabilities are a result of much larger effective diffusion distances that occur because the large aspect ratio of the treated filler layers forces the solutes to follow more tortuous paths in the polymer matrix around the treated filler layers. Additionally, the lower concentration of treated filler effects the crystallite size and quantity, thereby effecting the barrier property. Such barriers may be selective or non-selective depending on whether or not the barrier acts to prevent a specific gas or gases from penetrating or permeating the barrier material or structure. Thus, a water vapor or moisture barrier characteristic can be imparted on the polymer using suitable treated fillers to prevent penetration or permeation by water vapor. Similarly, an oxygen barrier can be provided to prevent penetration by oxygen (for example, oxygen as contained in the atmosphere) and a flavor or aroma barrier can be provided to prevent penetration by complex organic molecules that impart flavor or aroma. These barriers can act to prevent penetration or permeation by vapors or gases by means of certain physical or chemical properties that the barrier materials or barrier structures possess.

The products of the present invention provide increased shelf storage life for contents, including beverages and food that are sensitive to the permeation of gases. The composite films of the present invention often display a gas transmission or permeability rate (oxygen, carbon dioxide, water vapor) of at least 10% lower (depending on treated filler concentration) than that of similar films made from filler-free polymer, thus resulting in correspondingly longer product shelf life provided by the films.

The enhanced thermal stability of the polymer composite film and products fabricated therefrom is also attributable to the use of treated fillers. This enhanced thermal stability, and more specifically an increase of approximately 10-80° C. of heat distortion temperature, allows for greater applications of film products. For example, polystyrene and polyethylene films having treated fillers therein can be used in microwaves. Indeed, the temperature window for the majority of the polymeric film products of the present invention can be increased. Accordingly, certain polymer films can now be used for a broader range of applications. In addition, due to the enhanced physical properties such as stiffness and heat distortion, polymeric film composites of the present invention can be used as a replacement for foils.

In further accordance with the invention, the nucleation characteristics and crystallinity and crystalline morphologies of the polymer composite films are enhanced. The treated fillers allow for an increase in nucleation sites and overall smaller crystals. The treated fillers can serve as heterogeneous nucleation agents allowing more sites to nucleate and grow. This leads to an increase in cell density. While more cells start to grow at the same time, there is less opportunity for the individual cells to grow bigger, leading to a smaller cell size. The smaller and more dispersed spherulites enhance the clarity of the film while increasing its stiffness, toughness and ductility. Accordingly, polymeric film products such as, for example, sleeves, protective packaging, bags, liners, house-wraps, overwrap films, and bubble cushion having enhanced characteristics are fabricated from the polymer composite film of the present invention.

In further accordance with the invention, the polymer composite film of the present invention having treated fillers impart improved flame retardant characteristics. Accordingly, polymer film composites with treated fillers, such as, for example, polypropylene and polystyrene composites, have enhanced fire retardant characteristics and thus can be effectively used for broader applications. For example, polymeric films used as house-wraps have enhanced flame retardant characteristics.

The contents of all patents, patent applications, journals and books cited herein are hereby incorporated by reference in their entirety to more fully describe the state of the art to which the invention pertains.

It will be apparent to those skilled in the art that various modifications and variations can be made in the method and system of the present invention without departing from the spirit or scope of the invention. Thus, it is intended that the present invention includes modifications and variations that are within the scope of the appended claims and their equivalents.

1. A multi-layer polymer composite film comprising at least a first layer of polymer material and a second layer of polymer materials, at least on of the first layer and the second layer further including
a treated filler having a median particle size of about 0.1 nm-10 μm, the treated filler dispersed throughout the polymer material of the at least one of the first layer and the second layer.

2. The polymer composite film of claim 1, wherein the treated filler is treated by an edge-modifying technique.

3. The polymer composite film of claim 2, wherein the edge treated filler has a surfactant adsorbed onto the edges thereof.

4. The polymer composite film of claim 1, wherein the treated filler is exfoliated.

5. The polymer composite film of claim 1, wherein the treated filler is delaminated.

6. The polymer composite film of claim 1, wherein the treated filler is intercalated.

7. The polymer composite film of claim 1, wherein the treated filler is selected from the group consisting of calcium carbonate, wollastonite, silica and phyllosilicates.

8. The polymer composite film of claim 7, wherein the phyllosilicates are selected from the group consisting of mica, kaolinite, smectite clays and talc.

9. The polymer composite film of claim 1, wherein the polymer material of the at least one of the first layer and the second layer is selected from the group consisting of polypropylene, polyethylene, polystyrene, styrene butadiene copolymers, polyurethanes, polyesters, polycarbonate, polyacrylonitriles, polyamides, styrenic block copolymers, ethylene vinyl alcohol copolymers, ethylene vinyl acetate copolymers, polyesters grafted with maleic anhydride, polyvinylidene chloride, aliphatic polyketone, liquid crystalline polymers, ethylene methyl acrylate copolymer, ethylene-norbornene copolymers, polymethylpentene and ethylene acyrilic acid copoloymer, mixtures and copolymers thereof.

10. The polymer composite film of claim 1, wherein the polymer material of the first layer is different than the polymer material of the second layer.

11. The polymer composite film of claim 1, wherein a structural material of the first layer is different than a structural material of the second layer.

12. The polymer composite film of claim 1, further including a non-treated filler dispersed throughout the polymer material of at least one of the first layer and the second layer.

13. The polymer composite film of claim 1, wherein the film includes at least two different polymers, wherein at least on polymer contains a treated filler.

14. The polymer composite film of claim 13, wherein the at least two different polymers are incompatible.

15. A product produced at least in part from a polymer composite film, the film including:
a polymer capable of being formed into a polymeric film; and
a treated filler having a median particle size of about 0.1 nm-10 μm, wherein the treated filler is dispersed throughout the polymer.

16. The product of claim 15, selected from the group consisting of sleeves, protective packaging, films, bags, liners, house-wraps, overwrap films, bubble cushion, void fillers, packaging for food products, boil-in bags, heat shrinkable films, heat shrinkable bags, pouches, and thermoformed packages.

17. The product of claim 15, wherein the treated filler is treated by an edge-modifying technique.

18. The product of claim 17, wherein the edge treated filler has a surfactant adsorbed onto the edges thereof.

19. The product of claim 15, wherein the treated filler is exfoliated.

20. The product of claim 15, wherein the treated filler is delaminated.

21. The product of claim 15, wherein the treated filler is intercalated.

22. The product of claim 15, wherein the treated filler is selected from the group consisting of calcium carbonate, wollastonite, silica and phyllosilicates.

23. The product of claim 22, wherein the phyllosilicates are selected from the group consisting of mica, kaolinite, smectite clays and talc.

24. The product of claim 15, wherein the polymer material of the at least one of the first layer and the second layer is selected from the group consisting of polypropylene, polyethylene, polystyrene, styrene butadiene copolymers, polyurethanes, polyesters, polycarbonate, polyacrylonitriles, polyamides, styrenic block copolymers, ethylene vinyl alcohol copolymers, ethylene vinyl acetate copolymers, polyesters grafted with maleic anhydride, polyvinylidene chloride, aliphatic polyketone, liquid crystalline polymers, ethylene methyl acrylate copolymer, ethylene-norbornene copolymers, polymethylpentene and ethylene acrylic acid copolymer, mixtures and copolymers thereof.

25. The product of claim 15, wherein the film has a multi-layer construction.

26. The product of claim 25, wherein the treated filler is treated by an edge-modifying technique.

27. The product of claim 25, wherein the film includes at least a first layer of polymer material and a second layer of polymer material.

28. The product of claim 27, wherein the polymer of the first layer is different than the polymer of the second layer.

29. The product of claim 27, wherein a structural material of the first layer is different than a structural material of the second layer.

30. The product of claim 15, wherein the film further includes a non-treated filler dispersed throughout the polymer forming the polymer composite film.

31. The product of claim 15, wherein the film includes at least two polymers, wherein at least one polymer contains a treated filler.

32. The product of claim 31, wherein the at least two polymers are incompatible.

33. A method for producing a product formed at least in part from a polymer composite film, the method comprising:
fabricating a polymer composite film by
treating a filler to create a treated filler, wherein the treated filler is intercalated, exfoliated or delaminated;
dispersing the treated filler into a polymer matrix; and
forming the polymer matrix into a polymer composite film; and
forming the polymer composite film into the product.

34. The method of claim 33, wherein the product is selected from the group consisting of sleeves, protective packaging, films, bags, liners, house-wraps, overwrap films, bubble cushion, void fillers, packaging for food products, boil-in bags, heat shrinkable films, heat shrinkable bags, pouches, and thermoformed packages.

35. The method of claim 33, wherein the filler is treated by an edge-treatment process.

36. The method of claim 33, wherein the polymer matrix is formed into a polymer composite film through a processing technique selected from the group consisting of extrusion, extrusion coating, extrusion lamination, adhesive lamination, blown film, cast film, solution or solvent coating and a molding technique.

37. The method of claim 33, wherein the treated filler is dispersed in the polymerization process.

38. The method of claim 33, wherein the treated filler is dispersed in a solution or a solvent blending process.
